(19) United States
(12) Patent Application Publication
(10) Pub. No.: US 2023/0420950 A1
(43) Pub. Date: Dec. 28, 2023

(54) Natural Gas Generator System

(71) Applicant: Cardinal Energy Corp., Salem, VA (US)

(72) Inventors: Michael Terrance KELLEY, Chester, VA (US); Brian KISNER, Fort Collins, CO (US); Andrew Lee PRICE JR., Chesterfield, VA (US); ShuKai CHANG, Fremont, CA (US); Yu-Rong CHEN, Tainan City (TW)

(21) Appl. No.: 17/847,725

(22) Filed: Jun. 23, 2022

(51) Int. Cl. H02J 3/38; F02B 63/04; F02B 43/10

(52) U.S. Cl. CPC H02J 3/381; F02B 63/04; F02B 43/10; F02B 2043/103

(57) ABSTRACT

A backup power system and method of use is provided for powering at least one load wherein the at least one load is normally connected to grid power at a grid frequency. The system and method include providing a generator powered by a fuel in gas phase, such as natural gas; detecting loss of grid power to the at least one load; driving the generator to an operating frequency equal to a predetermined driven frequency that is greater than the grid frequency; and selectively coupling the at least one load to the generator via a load controller while the generator is at the predetermined driven frequency.

### FIELD

The present disclosure relates a generator system and, more particularly, relates to a backup power system configured to change an operating frequency of a natural gas generator to a driven frequency that is different from a grid frequency to aid in providing power to one or more loads.

### BACKGROUND

This section provides background information related to the present disclosure which is not necessarily prior art. This section provides a general summary of the disclosure and is not a comprehensive disclosure of its full scope or all of its features.

A power outage can severely impact your productivity or disrupt critical operations. In some businesses, this can mean substantial financial losses, for example in data centers, manufacturers, agricultural, or scientific research. In some businesses, power loss can even endanger people's lives, for example in hospitals, mining companies, and construction companies. Data centers are an example of a business where uninterrupted power continuity is particularly important because computers may not withstand even a sub-second power interruption. Data centers are typically a building, a group of buildings, or other dedicated space that is used to house and functionally support computer systems and associated components for telecommunications, internet technologies, and/or data-storage systems. Although the term “data center” was originally used to denote spaces set aside to house or accommodate racks or trays of computer systems and servers, it has more recently been used to denote entire facilities that also house systems for Internet connectivity and, even more recently, cloud-based data storage.

Data centers can be disposed in one room of a building, on one or more floors of a building, or can encompass a plurality of buildings throughout a large complex or campus. Due to the varying configurations, power, cooling, and associated costs of operation may vary depending on the necessary infrastructure and backup systems. In some configurations, various mechanical infrastructure is necessary to provide heating, ventilation, and air conditioning (HVAC); humidification and dehumidification equipment; and other systems. Likewise, in some configurations, electrical infrastructure is typically necessary to support the operations of the data center and may include utility grid systems; electrical distribution, switching, and bypass systems from power sources; uninterruptible power supply (UPS) systems; power-backup systems; and other systems.

### DRAWINGS

The drawings described herein are for illustrative purposes only of selected embodiments and not all possible implementations, and are not intended to limit the scope of the present disclosure.

FIG. 1 is a graph of voltage over time illustrating a conventional backup power startup system where a desired voltage is not maintained and causes a tripped voltage limit to be exceeded;

FIG. 2 depicts a process diagram of an illustrative backup power system according to the principles of the present teachings;

FIG. 3 depicts a flow chart of an illustrative method of providing backup power according to the principles of the present teachings;

FIG. 4 depicts a process diagram of an illustrative method of sequencing operation of the cooling system according to the principles of the present teachings;

FIG. 5 depicts a flow chart of an illustrative method of sequencing operation of the cooling system according to the principles of the present teachings;

FIG. 6A depicts a process diagram of the illustrative method of sequencing operation of the cooling system according to the principles of the present teachings; and

FIG. 6B depicts a process diagram of the illustrative method of sequencing operation of the cooling system according to the principles of the present teachings.

Corresponding reference numerals indicate corresponding parts throughout the several views of the drawings.

### DETAILED DESCRIPTION

Example embodiments will now be described more fully with reference to the accompanying drawings and appended claims. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Overview

With particular reference to power sources and backup systems, it should be recognized that power is one of the largest recurring costs to the user of a data center and represents, in most cases, the single most important input to maintain operation. For example, power is required to run computing systems, servers, data storage, etc. as well as systems cooling the data center. As can be appreciated, continual and reliable operation of data centers are crucial for community and utility services, business services, government support and services, and other services, and such operation is typically predicated on supplying sufficient and reliable power.

Traditionally, data centers get primary electrical power from the wider municipal electric grid. The data center may further employ various transformers and/or electrical componentry to ensure that the incoming grid power maintains the proper voltage and/or frequency. Data centers may supplement and/or replace grid power using on-site electrical generation equipment, such as stand-alone generators. These generators can form a part of a UPS system.

UPS systems also serve as an initial backup, in case of a power outage or similar issue. A typical UPS system can provide power to critical components for up to about five minutes to provide sufficient time to bring backup power generation systems online following an outage or similar issue with the wider electric grid power source.

In order to ensure continuous uptime and minimize outages as much as possible, most data centers have a backup power source on site or nearby. More often than not, backup power supply comes from a fuel generator, itself powered by gasoline or diesel, which typically output about 600 kW of power. However, natural gas systems are particularly desirable due to operational concerns (e.g., availability of fuel), reduced emissions, and cost reduction considerations.

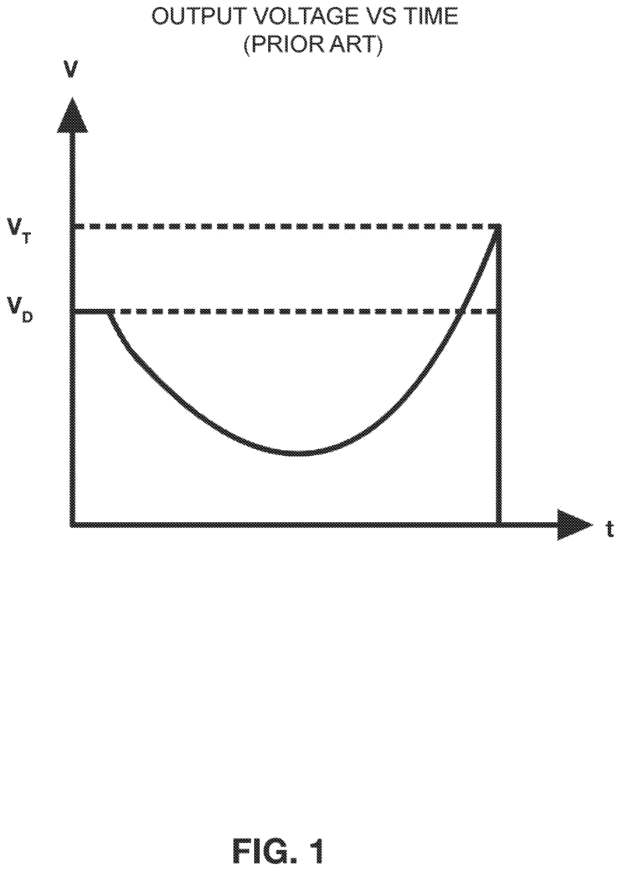

However, it has been found that such large natural gas generators (e.g., larger than 1500 kW) and/or combined generator and UPS systems do not meet the required needs during a power ramp-up cycle as power is switched from grid power to natural gas generators. That is, as illustrated in FIG. 1, during a ramp-up cycle the power demands of the data center are transferred from the temporary power output of the UPS to the generator system at a desired voltage level VD. However, as load is added to the generator system during a ramp loading phase, the actual voltage (indicated by the curve) may fall below the desired voltage level VD. This voltage decrease can result in the generator being driven above the desired voltage VD to a point where the output voltage triggers a trip voltage VT response causing the generator system to load shed to the UPS and shut down. It has been found that a common large-block natural gas generator has particular output levels that may be more susceptible or sensitive in ramp loading in two regions, depending on ambient conditions. For example, in some large block gas gensets, the first region occurs when emissions regulations kick in when output is about 500 kW, and the second region occurs when the engine transitions from carburetor to turbo because of the heat when output is about 800 kW. Unfortunately, this results in failure of the backup power system as the UPS is unable to maintain sufficient on-going power supply to the data center due to installed battery runtime.

Accordingly, there exists a need for a power backup system that is configured to provide backup power to meet the power demands of a data center in the event of loss of a primary power source. Additionally, there exists a need to provide a power backup system that is operable using natural gas to address operational concerns, reduce emissions, and reduce operational costs. A natural gas power backup system may produce power at a lower rate and/or with lower emissions than grid power and thus may also enable significant financial gains through load curtailment and/or to sell excess power to the grid, which data centers with conventional power backup systems cannot benefit from.

Therefore, according to the principles of the present teachings, a backup power system is provided having advantageous construction for supplying power to at least one load. The load is normally connected to grid power at a grid frequency. The backup power system includes a generator powered by a fuel in gas phase, such as natural gas; a power controller operably coupled to the generator configured to control an operating frequency of the generator; the power controller is configured to be coupled to the load, wherein the power controller is configured to output a generator control signal to the generator upon loss of the grid power to change an operating frequency of the generator to a predetermined driven frequency greater than the grid frequency, and wherein the power controller is configured to selectively couple the at least one load to the generator at the predetermined driven frequency.

Additionally, according to the principles of the present teachings, a method of providing a backup power system is provided to supply power to at least one load. The load is normally connected to grid power at a grid frequency. The method includes providing a generator powered by a fuel in gas phase, such as natural gas; detecting loss of grid power to the load; driving the generator to an operating frequency equal to a predetermined driven frequency that is greater than the grid frequency; and selectively coupling the at least one load to the generator via a power controller while the generator is at the predetermined driven frequency.

Backup Power System

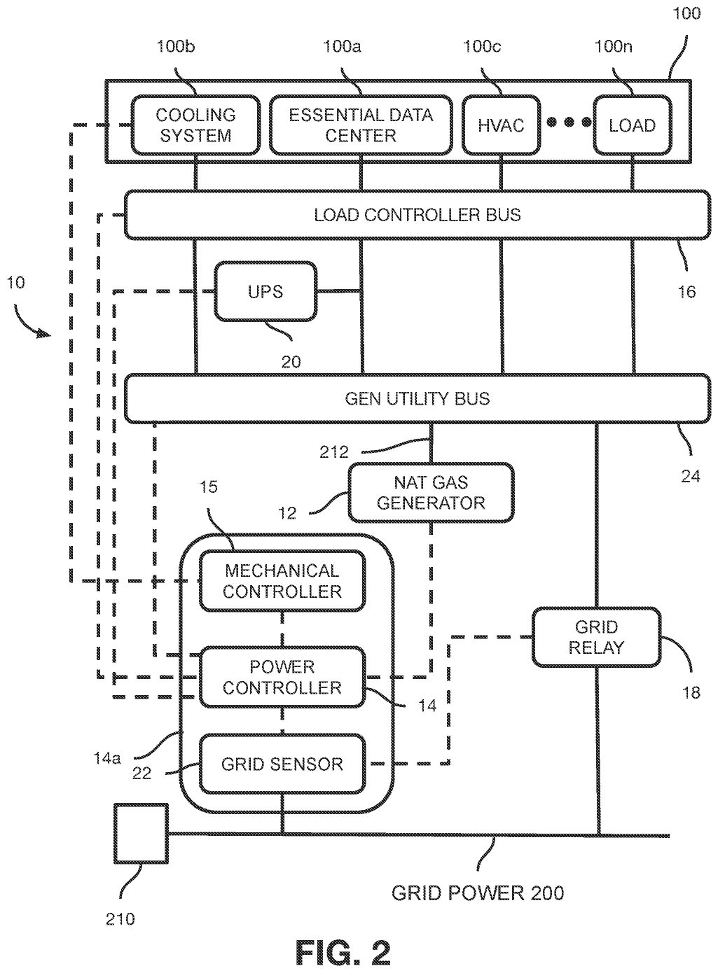

In accordance with the teachings of the present disclosure, and with reference to FIG. 2, a backup power system 10 is provided having advantageous construction and method of operation. The backup power system 10 is configured to be used to provide backup electrical power to a data center 100 or other load requiring electrical power on the order of 500 kW or greater. The data center 100 is configured to receive a primary electrical input or grid power 200 from a primary power source 210. In some embodiments, the primary power source 210 is a municipal power source providing grid power 200 at a predetermined voltage and frequency. In some embodiments, grid power 200 is provided at a nominal voltage of 120 V per phase and a frequency of 60 Hz (in the United States). In some embodiments, grid power 200 is provided at a nominal voltage of 230 V and a frequency of 50 Hz (in much of the world). It should be understood that in some embodiments the primary power source 210 and associated power delivery system may include power input connections, protective relays, breakers, interrupters, transformers, or any component necessary to deliver power for electrical operation of the data center 100.

As illustrated in FIG. 2, in some embodiments, a backup power system 10 is electrically coupled between grid power 200 and one or more loads of the data center 100. In some embodiments, data center 100 can comprise a plurality of electrical loads 100a, 100b, 100c, . . . , 100n comprising, but not limited to, an essential data center load 100a (e.g., computer systems, servers, data storage, communication systems, etc.), a cooling system load 100b, an HVAC load 100c, and any additional load 100n.

With continued reference to FIG. 2, in some embodiments, a backup power system 10 can comprise one or more generators 12, one or more power controllers 14, one or more mechanical controllers 15, and a load controller bus 16. It should be understood that in some embodiments the one or more mechanical controllers 15 can be incorporated in and made a part of the one or more power controllers 14 (illustrated generally as the combined box having reference number 14a in FIG. 2) or can be separate from the one or more power controllers 14 (illustrated generally as a separate mechanical controller 15 being spaced apart from the power controller 14 in FIG. 2). In some embodiments, the backup power system 10 comprises a grid relay 18 coupled to grid power 200. Moreover, in some embodiments, the backup power system 10 can comprise or be operably coupled to a temporary power supply system 20, such as but not limited to a UPS.

With particular reference to FIG. 2, in some embodiments, the generator 12 can comprise a generator powered by a fuel in gas phase. In some embodiments, the generator 12 comprises a natural gas generator that is configured to operate on natural gas. In some embodiments, the generator 12 has a continuous output of 600 kW or smaller. Generally, an output of the generator 12 can be varied in response to a change in the operating settings, such as the revolutions per minute (rpm). Generally, the generator 12 can be operated at a setting of 1500 rpm. The generator 12 can comprise a gearbox to map an output of the generator 12 to a desired frequency. In some embodiments, the desired frequency can be equal to a grid frequency (e.g., about 50 Hz or 60 Hz, or in some embodiments equal to about 59.5-60.5 Hz) or equal to another frequency (e.g., a driven frequency discussed herein). However, as will be discussed herein, the output frequency of the generator 12 can be varied between a first frequency and at least a second frequency to achieve unanticipated benefits over conventional generator sets.

In some embodiments, the power controller 14 is operably coupled to the generator 12 and configured to control one or more operating parameters of the generator 12. In some embodiments, the power controller 14 can initiate a start-up cycle in the generator 12, can terminate operation of the generator 12, can vary one or more operational settings of the generator 12 (e.g., a power output, a running frequency and thus geared output frequency, and the like), or otherwise sense, detect, and/or monitor one or more conditions of the generator 12. In some embodiments, the power controller 14 is configured to output a generator control signal to the generator 12 to control an operation of the generator 12. In some embodiments, the power controller 14 is configured to receive a generator response signal from the generator 12 indicative of a parameter of the generator 12, such as, for example, an operating frequency of the generator 12. In some embodiments, the power controller 14 can comprise an integrated grid sensor 22 operably coupled directly and/or indirectly to grid power 200 to sense, detect, or otherwise determine status and/or loss of grid power 200. A grid sensor 22 can output a grid signal to the power controller 14 in response to or indicative of loss of grid power 200. It should be understood that in some embodiments the grid sensor 22 can be incorporated in and made a part of the power controller 14 (illustrated generally as the combined box having reference number 14a in FIG. 2) or can be separate from the power controller 14 (illustrated generally as a separate grid sensor 22 being spaced apart from the power controller 14 in FIG. 2).

In some embodiments, the power controller 14 is operably coupled to the load controller bus 16. In some embodiments, a load controller bus 16 is provided and operably coupled between the generator 12, grid relay 18, and UPS to receive electrical power from at least one of the generator 12, grid power 200, and UPS 20 for distribution to one or more loads 100 (100a, 100b, 100c, . . . , 100n). In some embodiments, the grid and generator may be connected to a generator utility bus 24 ahead of the load controller bus 16. The power controller 14, in some embodiments, is configured to communicate with the load controller bus 16 to selectively control coupling and decoupling of each of the individual loads 100 from electrical power supplied by the generator 12, grid power 200, and/or UPS 20. For example, during a failure of grid power 200 the essential data center load 100a may be coupled to the electrical power supplied by the UPS 20, while the HVAC load 100c may be decoupled from the electrical power supplied by the UPS 20. Other examples exist.

In some embodiments, a grid relay 18 is operably coupled between the grid power 200 and the generator utility bus 24. The grid relay 18 is configured to selectively control coupling and decoupling of the generator utility bus 24 and grid power 200. In some embodiments, the grid relay 18 is configured to receive a relay signal from the power controller 14 to selectively open the grid relay 18 upon detection of failure of grid power 200 and/or selectively close the grid relay 18 upon detection of presence of grid power 200. In this way, the grid relay 18, responsive to the power controller 14, can selectively provide grid power 200 to the load controller bus 16, and/or loads 100.

In some embodiments, the UPS 20 is operably coupled between the power controller 14 and the load controller bus 16. The UPS 20 is configured to automatically provide stored electrical power to the load controller bus 16 in response to loss of grid power 200. In some embodiments, the UPS 20 comprises a battery system configured to provide temporary power to the load controller bus 16 at a frequency generally equal to grid frequency. In some embodiments, the UPS 20 is responsive to a UPS control signal from the power controller 14 and can output a UPS status signal to the power controller 14 indicative of an operational status, such as ON/OFF, power delivery, power output, output frequency, temperature, and the like.

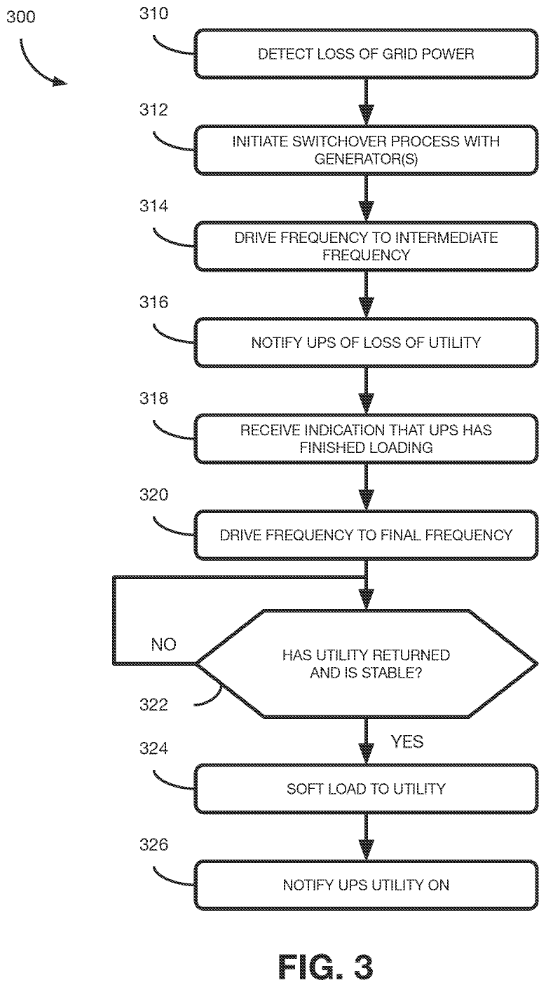

FIG. 3 illustrates an example method 300 performed by a processing device for a power controller (such as, for example, power controller 14 of FIG. 2) of a power system for a data center 100 according to some embodiments of the present disclosure. The method 300 may include one or more operations, functions, or actions as illustrated in one or more steps 310-326. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

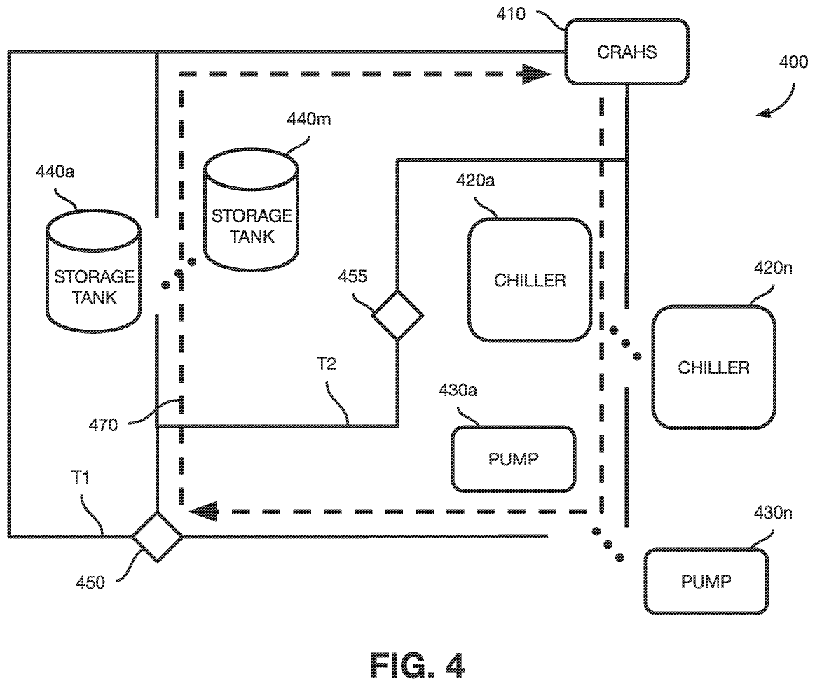

At Step 310 a loss of grid power 200 is detected, sensed, and/or otherwise determined. In some examples, the one or more grid sensors 22 can detect, sense, and/or determine when disruption, cessation, or partial loss of grid power 200 from primary power source 210 occurs, and transmit an indication of the status of grid power 200 to the power controller 14. The indication may be, for example, transmitted to the power controller 14 via a dedicated control wire or bus connecting the one or more grid sensors 22 to the power controller 14. In some examples, once the loss of grid power 200 is determined, an indication of the loss of grid power 200 is transmitted from the power controller 14 to the mechanical controller 15 to initiate a mechanical procedure for power failure (described in more detail below with reference to FIGS. 4-6). The indication may be, for example, transmitted to the mechanical controller 15 via a dedicated control wire or bus.

At Step 312, the power controller 14 can initiate a switchover process with the generator 12. In one example, the power controller 14 can output a relay signal to the grid relay 18 to disconnect (e.g., open the grid relay 18) the load controller bus 16 (and/or one or more loads 100a, 100b, 100c, . . . , 100n) from grid power 200. Additionally, the power controller 14 can transmit a generator control signal to the generator 12 to initiate a generator startup sequence. It should be understood that the generator 12 may require non-zero time to achieve one or more proper operating parameters, including but not limited to temperature, pressure, output frequency, output voltage, operating speed (rpm), and the like, prior to connecting the generator 12 to the load controller bus 16 (and/or one or more loads 100a, 100b, 100c, . . . , 100n).

At Step 314, the power controller 14 can output a generator control signal to the generator 12 to drive the generator 12 to an intermediate output frequency. The generator control signal may be, for example, transmitted to the generator 12 via a dedicated control wire or bus connecting the generator 12 to the power controller 14. In one example, the power controller 14 can output a generator control signal to the generator 12 to drive the generator 12 to a driven frequency above the nominal operating frequency of grid power 200. For example, for applications in the United States with a nominal operating frequency of 60 Hz, the driven frequency can be approximately 61.5 Hz, or within a range of approximately 61 Hz to 62 Hz. In another example, for applications outside of the United States with a nominal operating frequency of 50 Hz the driven frequency can be approximately 51.5 Hz, or within a range of approximately 51 Hz to 52 Hz. In this way, it should be understood that the power controller 14 is outputting a generator control signal to the generator 12 to drive the generator 12 to a driven frequency that is different from the grid operating frequency of the associated grid power 200. Thus, in some embodiments, the power controller 14 can output a generator control signal to the generator 12 to drive the generator 12 to a driven frequency that is greater than the grid operating frequency. In some examples, the power controller 14 controls a generator governor that controls a rotational speed of the generator 12, such as to a speed of about 1537 rpm, for example, which results in a frequency of about 61.5 Hz. In some embodiments, the generator 12 can output a generator signal to the power controller 14 indicative of the actual or current operating frequency of the generator 12 to provide feedback control of the generator 12 by the power controller 14. Upon determination that actual operating frequency of the generator 12 sufficiently meets a predetermined frequency, the power controller 14 can cause a generator breaker to close (not shown) to operably couple the generator 12 to the load controller bus 16.

At Step 316, the power controller 14 can notify the UPS 20 of loss of grid power 200. The UPS 20 can supply power from its battery system or other power storage system to the load controller bus 16 to provide power to loads 100 via power controller 14. UPS 20 can continue to supply power to load controller bus 16 until the generator 12 and/or main power is restored. Operation of the UPS 20 may be time limited (e.g., 5 minutes) due to heat, capacity, and/or other operational limits.

At Step 318, the power controller 14 can further receive a UPS status signal indicating the operating status of UPS 20 (i.e., that the UPS has finished loading). In response to generator signal, UPS status signal, and/or a predetermined time delay, power controller 14 can begin a modified ramp transition process of transitioning loads 100a, 100b, 100c, and/or 100n to be driven by generator 12 at the driven frequency. This modified ramp transition process continues until load is moved from UPS 20 to generator 12. While maintaining the driven frequency during this modified ramp transition, conventional UPS frequency of a lower frequency (e.g., 55 Hz) is avoided thereby preventing a trip condition of generator 12 and enabling continued operation of generator 12. In some embodiments, UPS 20 and/or power controller 14 can monitor frequency and if the frequency is below a predetermined frequency, such as 61.0 Hz, can pause offload from UPS 20 to generator 12 until frequency increases above 61.0 Hz. In some embodiments, cooling fluid or water can be opened. Upon detection of completion of modified ramp transition from UPS 20 to generator 12 (such that a load on UPS 20 is zero), which can be indicated by the opening of relays or contacts or output of the UPS status signal, ancillary loads (e.g., load not typically carried or powered by UPS 20) can be brought online and carried by generator 12. These ancillary loads can include various HVAC loads 100c or other loads 100n. Once generator 12 is fully loaded, additional systems, such as chillers, can be activated, including switching valves to flow water from chillers direct to data hall, maintaining cooling to data hall computer room air handlers (CRAHs) until a temperature difference (13° F.) is achieved, and then modulating valves between mixing stored water back into return to be chilled until tank water and supply water are within 2° F.

In Step 320, power controller 14 drives the frequency of generator 12 back to the grid frequency (e.g., 60 Hz) and outputs the UPS control signal to indicate generator 12 is fully operational and UPS 20 is deactivated. In some embodiments, UPS 20 can again set an acceptable frequency band (e.g., 55-60 Hz).

At Step 322, grid sensor 22 and/or power controller 14 can monitor grid power 200 to determine if grid power 200 has returned and/or is stable. If grid power 200 has not returned or does not have the required output, voltage, frequency, and/or stability, grid sensor 22 and/or power controller 14 can continue to monitor grid power 200 until otherwise. If grid power 200 has returned and provides the required output, voltage, frequency, and/or stability, then a soft load back to grid power 200 can be initiated.

In Steps 324 and 326, power controller 14 can begin a soft load back to grid power 200 by discontinuing a UPS control signal (e.g., “loss of utility/on generator”). In some embodiments, power controller 14 can bring loads 100a, 100b, 100c, . . . , 100n on grid power 200 by actuating grid relay 18 through a conventional process. It should be recognized that the frequency of generator 12, during the soft load process, is generally equal to the frequency of grid power 200. Once complete, power controller 14 can return to a monitoring condition for further detection of loss of grid power.

FIG. 4 depicts an example cooling process flow 470 of a mechanical cooling system 400 for a data center under typical operating conditions wherein power to the data center is delivered using, for example, grid power. The mechanical cooling system 400 includes representations of several functional components interconnected via a piping system that allows chilled coolant to flow through the system for cooling purposes. The mechanical cooling system 400 includes various computer room air handlers (CRAHs) 410, one or more chillers 420a, . . . , 420n, one or more pumps 430a, . . . , 430n, one or more storage tanks 440a, . . . , 440m, control valves 450 and 455, and temperature sensors T1 and T2. The CRAHs 410 are designed to keep the data center loads (e.g., loads 100 in FIG. 1) at a target operating temperature, and for example, use fans and chilled coolant coils to remove heat. The chillers 420 cool the liquid coolant to be delivered to the CRAHs 410. Each chiller 420 includes one or more valves (not shown) that can be used to incorporate the chiller 420 into the cooling system. Depending on the data center loads and/or ambient temperature, additional or fewer chillers 420 may be required to cool the system. The storage tanks 440 are used to provide chilled coolant on a temporary basis in the event the chillers 420 are not available. To maintain chilled coolant in the storage tanks, chilled coolant from the chillers is passed through the storage tanks before being delivered to the CRAHs. The pumps 430 are used to move the coolant through the system, including, for example, through the CRAHs 410, the chillers 420, and the storage tanks 440. The process flow 470 shown in FIG. 4 depicts a closed loop system wherein coolant flows through the one or more chillers 420a, . . . , 420n, through the one or more pumps 430a, . . . , 430n, through the one or more storage tanks 440a, . . . , 440m, and through the CRAHs 410.

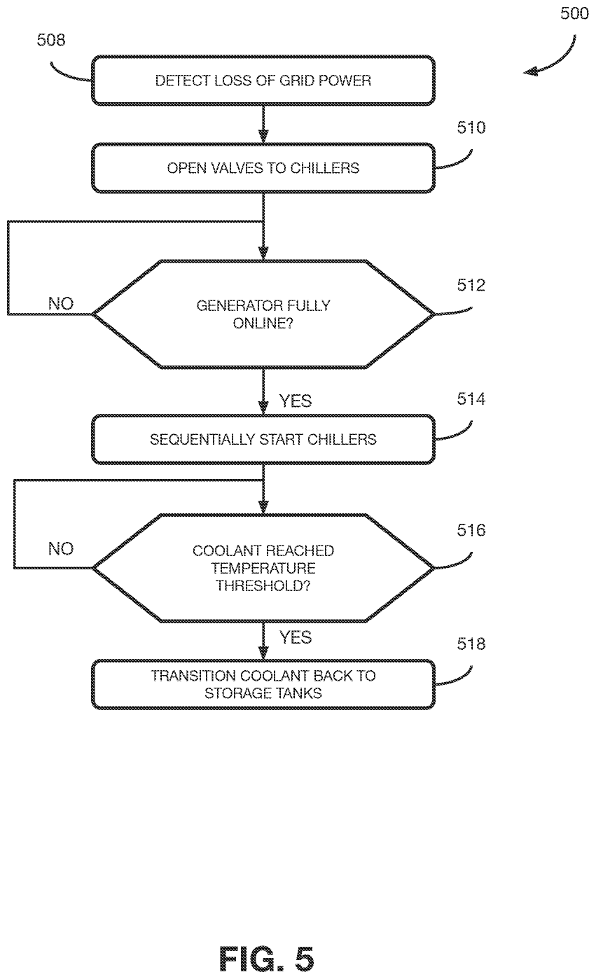

FIG. 5 depicts an example method 500 that may be executed by a processing device for a mechanical controller (such as, for example, the mechanical controller 15 of FIG. 2) of a power system for a data center 100 according to some embodiments of the present disclosure. The method 500 may include one or more operations, functions, or actions as illustrated in one or more steps 508-518. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In block 508, the mechanical controller 15 receives an indication of loss of grid power from the power controller 14. The indication may be, for example, transmitted to the mechanical controller 15 via a dedicated control wire or bus connecting the mechanical controller 15 to the power controller 14. In some examples the mechanical controller 15 is the same controller as the power controller 14. As mentioned above with reference to FIG. 3, the power controller 14 may notify the UPS 20 of the loss of power, and the UPS 20 may supply emergency power to essential systems such as, for example, elements of the cooling system 400 shown in FIG. 4. The UPS 20 can continue to supply power to elements of the cooling system 400 until the generator 12 and/or main power is restored. Operation of the UPS 20 may be time limited (e.g., 5 minutes) due to heat, capacity, and/or other operational limits.

In one example, with reference to the mechanical system 400 of FIG. 4, electrical power is not supplied to the chillers 420 by the UPS 20 during loss of grid power 200. Power is instead supplied to the chillers once power is restored using either generator power 212 or grid power 200. Additionally, one or more pumps 430 may receive electrical power from the UPS 20 during loss of grid power 200, to continue to cool the system using chilled coolant from one or more storage tanks 440.

In block 510, the mechanical controller 15 may cause the valves to the chillers 420 to be opened to allow coolant to flow through all of the chillers even though the chillers are not receiving electrical power. With reference to the mechanical system 400 of FIG. 4, the process flow through the mechanical system 400 follows the same path as the process flow 470 shown in FIG. 4, with the difference that the chillers are not powered. Instead, chilled coolant from the storage tanks 440 is the source of chilled coolant in the system. Depending on the size and number of storage tanks, chilled coolant may be provided to the CRAHs for a limited time (e.g., 5-10 minutes) before the temperature of the coolant is too high to provide effective cooling.

In block 512, the mechanical controller 15 determines if the generator is fully online (see, for example, block 322 of FIG. 3) and the mechanical system moves to a recovery mode. For example, the power controller 14 may transmit an indication that grid power is restored once the power controller 14 has determined that grid power 200 has returned and provides the required output, voltage, frequency, and/or stability.

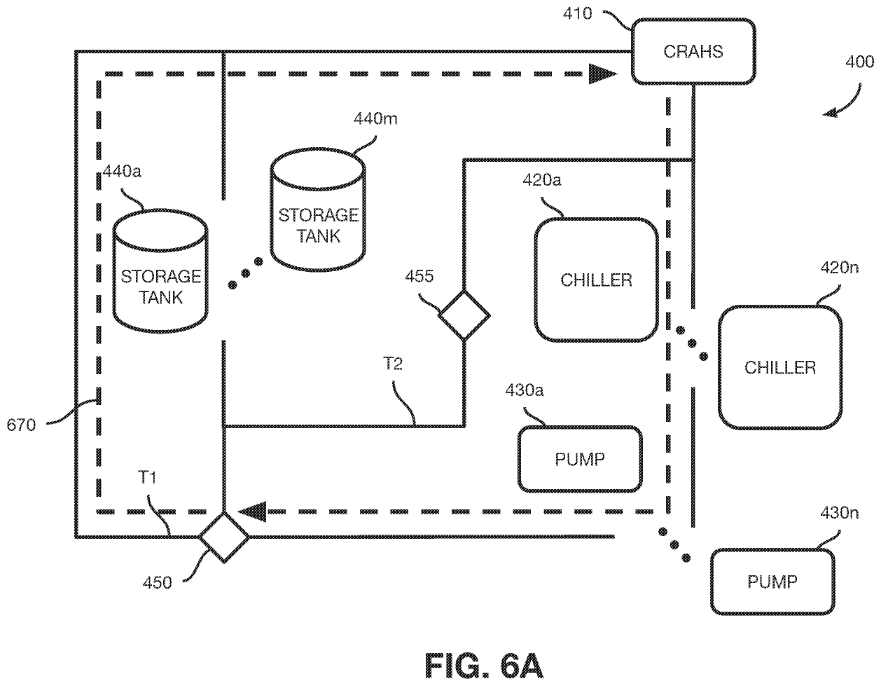

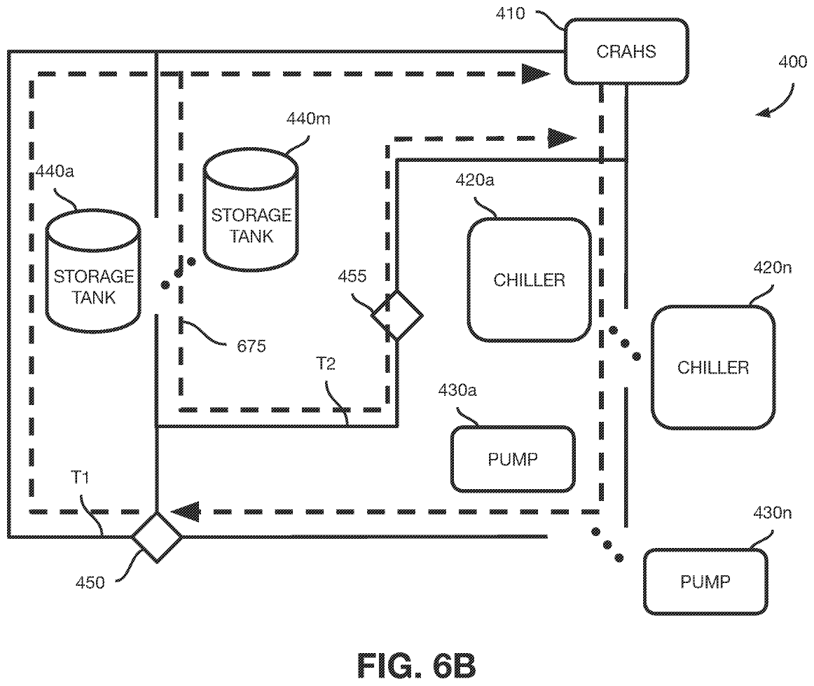

In block 514, the mechanical controller 15 may cause the chillers to be started sequentially to avoid overloading the system. With reference to FIG. 6A, the mechanical controller 15 can cause the control valve 450 to direct coolant directly to the CRAHs 410 without passing through the storage tanks 440. The process flow 670 shown in FIG. 6A depicts a closed loop system wherein coolant flows through the one or more chillers 420a, . . . , 420n, through the one or more pumps 430a, . . . , 430n, and through the CRAHs 410. This allows the newly chilled coolant from the chillers 420 to flow directly into the CRAHs. As the chillers 420 are started, the water temperature will drop as can be measured by temperature sensor T1 and transmitted to the mechanical controller 15. The temperature may be, for example, transmitted to the mechanical controller 15 via a dedicated control wire or bus.

In block 516, the mechanical controller 15 determines if the coolant temperature has reached a threshold indicating the mechanical system 400 is effectively cooling the CRAHs. This can be determined, for example, by comparing the measured temperature by temperature sensor T1 with a temperature threshold value.

In block 518, once the temperature has reached a threshold, the system transitions coolant back to the storage tanks. With reference to FIG. 6B, the mechanical controller 15 can cause the control valve 455 to (e.g., partially) open to allow coolant to dose into the return path from the storage tanks 440 directly to the chillers 420. This blends the (e.g., warmer) coolant from the storage tanks with the (e.g., warmer) coolant from the CRAHs into the chillers. The process flow 675 shown in FIG. 6B depicts two branches of a closed loop system. In the first branch coolant flows through the one or more chillers 420a, . . . , 420n, through the one or more pumps 430a, . . . , 430n, and through the CRAHs 410. In the second branch coolant flows through the one or more chillers 420a, . . . , 420n, through the one or more pumps 430a, . . . , 430n, through the one or more storage tanks 440a, . . . , 440m, and back to the chillers 420a, . . . , 420n, bypassing the CRAHs. This process flow 675 can continue until, for example, the mechanical controller 15 determines the temperature of the coolant measured by the temperature sensor T1 is within a threshold value of the temperature of the coolant measured by the temperature sensor T2. The temperatures may be, for example, transmitted to the mechanical controller 15 via a dedicated control wires or bus. Once the temperatures are within a threshold value, the system can return to the process flow 470 as shown in FIG. 4.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A backup power system for providing power to at least one load, the at least one load being normally connected to grid power at a grid frequency, the backup power system comprising:
a generator powered by a fuel in gas phase;
a power controller operably coupled to the generator, the power controller configured to control an operating frequency of the generator; and
the power controller configured to be coupled to the at least one load,
wherein the power controller is configured to output a generator control signal to the generator upon loss of the grid power to change an operating frequency of the generator to a predetermined driven frequency greater than the grid frequency, and
wherein the power controller is configured to selectively couple the at least one load to the generator at the predetermined driven frequency.

2. The backup power system according to claim 1 further comprising an uninterruptible power supply operably coupled to the power controller, the uninterruptible power supply configured to automatically provide stored electrical power to the power controller in response to loss of the grid power.

3. The backup power system according to claim 2, wherein the uninterruptible power supply is configured to gradually transition load demand from the uninterruptible power supply to the generator while the generator operating frequency remains at the predetermined driven frequency.

4. The backup power system according to claim 3, wherein the uninterruptible power supply is configured to discontinue the gradual transition of load demand from the uninterruptible power supply to the generator if the generator operating frequency is below the predetermined driven frequency.

5. The backup power system according to claim 2, wherein the uninterruptible power supply is operably coupled to the power controller to output an uninterruptible power supply status signal to the power controller regarding an operation status of the uninterruptible power supply.

6. The backup power system according to claim 2, wherein the uninterruptible power supply is operably coupled to the power controller to receive an uninterruptible power supply control signal from the power controller to control an operational parameter of the uninterruptible power supply.

7. The backup power system according to claim 1, wherein the power controller is configured to output the generator control signal to the generator to change the operating frequency of the generator to the grid frequency when the at least one load is coupled to the generator.

8. The backup power system according to claim 1, wherein the power controller is configured to determine the grid power.

9. The backup power system according to claim 1 further comprising a grid relay operably coupled between the grid power and the at least one load, where the power controller is configured to control the grid relay to selectively disconnect the at least one load from the grid power.

10. The backup power system according to claim 1, wherein the power controller is configured to selectively couple the at least one load to the generator after a predetermined delay.

11. The backup power system according to claim 1, wherein the fuel in gas phase is natural gas.

12. The backup power system according to claim 1, wherein the grid frequency is in the range of 59.5-60.5 Hz.

13. The backup power system according to claim 1, wherein the predetermined driven frequency is in the range of 61-62 Hz.

14. A method of providing a backup power system providing power to at least one load, the at least one load being normally connected to grid power at a grid frequency, the method comprising:
providing a generator powered by a fuel in gas phase;
detecting loss of grid power to the at least one load;
the driving the generator to an operating frequency equal to a predetermined driven frequency, the predetermined driven frequency being greater than the grid frequency; and
selectively coupling the at least one load to the generator via a power controller while the generator is at the predetermined driven frequency.

15. The method according to claim 14, wherein the detecting loss of grid power to the at least one load further comprises initiating a switchover process opening a grid relay to selectively disconnect the at least one load from the grid power.

16. The method according to claim 14 further comprising providing an uninterruptible power supply operably coupled to the power controller, the uninterruptible power supply automatically providing stored electrical power to the power controller in response to loss of the grid power.

17. The method according to claim 16, wherein the uninterruptible power supply gradually transitions load demand from the uninterruptible power supply to the generator while the generator operating frequency remains at the predetermined driven frequency.

18. The method according to claim 17, wherein the uninterruptible power supply discontinues the gradual transition of load demand from the uninterruptible power supply to the generator if the generator operating frequency is below the predetermined driven frequency.

19. The method according to claim 14 further comprising driving the generator to an operating frequency equal to the grid frequency when the at least one load is coupled to the generator.

20. The method according to claim 14, wherein the selectively coupling the at least one load to the generator via the power controller while the generator is at the predetermined driven frequency occurs after a predetermined delay.

21. The method according to claim 14, wherein the fuel in gas phase is natural gas.

22. The method according to claim 14, wherein the grid frequency is in the range of 59.5-60.5 Hz.

23. The method according to claim 14, wherein the predetermined driven frequency is in the range of 61-62 Hz.
